(19) United States
(12) Patent Application Publication
(10) Pub. No.: US 2005/0172845 A1
(43) Pub. Date: Aug. 11, 2005

(54) Valuable paper transmission/reception device, valuable paper transmission/reception system, and valuable paper transmission/reception method

(76) Inventors: Junichi Umehara, Saitama-ken (JP); Youichi Nihei, Kanagawa-ken (JP); Yasuo Kotera, Fukishima-ken (JP); Takao Tazawa, Kanagawa-ken (JP)

Correspondence Address: BRINKS HOFER GILSON & LIONE, P.O. BOX 10395, CHICAGO, IL, 60610, US

(21) Appl. No.: 10/512,717

(22) PCT Filed: Apr. 30, 2003
(86) PCT No.: PCT/JP03/05517

(30) Foreign Application Priority Data
May 1, 2002 (JP) 2002-129985
May 1, 2002 (JP) 2002-129986
May 1, 2002 (JP) 2002-129987

(51) Int. Cl. B41F 1/00

(52) U.S. Cl. 101/477

(57) ABSTRACT

A certificate transceiver includes a CCD sensor unit for reading certificate data from a certificate, a printing unit for writing data into a certificate form, and a network interface for transmitting and receiving data via the communication line. A certificate transmitter side reads and transmits certificate data of the original certificate and writes invalidating data into the certificate by the printing unit. A certificate receiver side writes the received certificate data into a certificate form by the printing unit.

### TECHNICAL FIELD

The present invention relates a certificate transceiver, a certificate transceiver system, and a certificate transmission and reception method for transmitting and receiving tickets including securities (such as stock certificates, credits, exchange coupons, etc.), audience tickets (for music, drama, sports events, etc.), and transportation tickets (airline tickets, railway tickets, etc.).

### BACKGROUND ART

When a stock is transferred to a new stock holder, a transfer agent such as a dedicated agent or a trust bank transfers the name of the stock holder and issues a new stock certificate to the new stock holder. For example, when a stock owned by an original stock holder living in Tokyo is name-transferred to a new stock holder living in Osaka, the stock transfer agent carries or mails a name-transferred stock certificate to the new stock holder in Osaka.

In the above-mentioned conventional issuing method, it takes a lot of time and effort to issue and deliver a stock certificate to a new stock holder in a remote place. It is contemplated that a transfer agent transmits stock data of an original stock holder via a communication line, such as the Internet, to a receiving side and that the receiving side then issues a new stock certificate. In such a case, the original stock certificate, remaining in the transmitting side, is subject to an unauthorized use including counterfeiting unless the original stock certificate is reliably revoked.

This problem can equally arise in any certificates of value, such as securities (such as stock certificates, credits, exchange coupons, etc.), audience tickets (for music, drama, sports events, etc.), and transportation tickets (airline tickets, railway tickets, etc.).

When individuals mutually exchange an audience ticket, a transportation ticket, etc., the ticket is directly handed over or mailed to a receiver. If the receiver is in a business trip, he may wish to receive the ticket at a trip destination.

The present invention has been developed in view of this problem, and it is an object of the present invention to issue a new certificate based on an original certificate via a communication line while protecting the original certificate from an unauthorized use.

It is also another object of the present invention to allow a new holder to receive a newly issued stock certificate at a place desired by the new holder.

### DISCLOSURE OF INVENTION

To overcome the above-mentioned drawback, a certificate transceiver of the present invention includes data reading means, data writing means, storage means for temporarily storing data read by the data reading means, and communication means for transmitting and receiving data via a communication line. When the data of a certificate of value is transmitted, the data reading means reads data from the certificate, the storage means stores the certificate data, the communication means transmits the certificate data, and the data writing means writes invalidating data on the certificate to invalidate the certificate data, and deletes the certificate data from the storage means. When the certificate data is received, the data writing means writes certificate data received, by the communication means, onto a recording medium of a certificate.

In the certificate transceiver, the certificate transceiver on a certificate transmitter side transmits, via the communication line, the certificate data read from the original certificate and the certificate transceiver on a certificate receiver side writes the certificate data onto the recording medium for the certificate. The new certificate is produced and issued via the communication line based on the original certificate. Since the certificate transceiver on the certificate transmitter side invalidates the original certificate, an unauthorized use of the original certificate is prevented.

The recording medium may include a contactless rewritable non-volatile memory. The data reading means reads data from the non-volatile memory, embedded in the certificate, in a contactless manner, and the data writing means writes data onto the non-volatile memory, embedded in the certificate, in a contactless manner.

Since the certificate transceiver produces a new certificate with the certificate data written onto the non-volatile memory, it is difficult to counterfeit certificate.

The certificate transceiver may include data printing means. To invalidate the data of the certificate, the data printing means writes the invalidating data on the certificate.

In the certificate transceiver, the data printing means performs an overwrite process by printing the invalidating data on the original certificate. The invalided certificate is thus visually recognized, and is reliably revoked. Since the overwrite process invalidates the original certificate, the data of the original certificate remains without being deleted. This arrangement allows the data of the original certificate to be checked.

The certificate transceiver may include certificate information storage means for storing the certificate data with certificate identification information associated therewith for identifying the certificate. During the transmission, the data reading means reads the certificate identification information recorded on the certificate, and the communication means transmits the read data of the certificate identification information. During the reception, the certificate data is read from the certificate information storage means in accordance with the data of the certificate identification information received by the communication means, and the data writing means writes the certificate data onto the recording medium.

The certificate transceiver on the certificate transmitter side transmits only the certificate identification information of the original certificate, and the certificate transceiver on the certificate receiver side writes data on a new certificate based on the certificate identification information. In this arrangement, the amount of information transmitted from the certificate transmitter side to the certificate receiver side is reduced, and process time is shortened.

At least variable data of the certificate data is modifiable in the certificate transceiver.

Since the certificate transceiver modifies at least the variable data (such as data of a stock holder name), data (such as the data of a new stock holder name) different from the original certificate is written onto a new certificate.

The certificate transceiver may include data input means. The variable data is modified by entering data via the data input means.

Since the variable data is modified by the input data in the certificate transceiver, an operator can directly input data desired to be recorded on the new certificate.

In the certificate transceiver, the communication means may establish a connection with a database that is accessible via a communication line and has recorded the latest variable data and the variable data is modified in accordance with the content of the database.

Since the new certificate is produced with the data thereof automatically updated with the latest variable data (such as the data of the stock holder name), the operator is freed from time otherwise consumed for rewriting the variable data.

To overcome the above-referenced drawback, a certificate transceiver system of the present invention includes a certificate transmitter including reading means for reading certificate information recorded on a certificate of value, invalidating means for invalidating the certificate, and first communication means for transmitting the certificate information via a communication line, and a certificate receiver including second communication means for receiving the certificate information via the communication line, and writing means for writing the received certificate information onto a recording medium of the certificate.

In the certificate transceiver system, the certificate transmitter (corresponding to a certificate transceiver 1 on a certificate transmitter side of FIG. 1) transmits the certificate information, read from the original certificate via the communication line, and the certificate receiver (corresponding to a certificate transceiver 1 on a certificate receiver side of FIG. 1) writes the received certificate information onto the recording medium for the certificate. A new certificate is thus produced and issued via the communication line based on the original certificate. Since the certificate transmitter invalidates the original certificate, an unauthorized use of the original certificate is prevented.

The certificate transceiver system may include certificate information storage means for storing image data, as one piece of the certificate information with certificate identification information associated therewith for identifying the certificate. The reading means reads the certificate identification information as one piece of the certificate information. The first communication means transmits the read certificate identification information via the communication line. The writing means acquires the image data, from the certificate information storage means, corresponding to the certificate identification information received by the second communication means, writes the image data onto an image recording medium, and writes the certificate identification information onto a digital recording medium.

Since the certificate transmitter transmits the certificate identification information of the original certificate and the certificate receiver writes information on a new certificate based on the certificate identification information in the certificate transceiver system, the amount of information transmitted form the certificate transmitter side to the certificate receiver side is reduced, and process time is shortened. The image recording medium that permits an image to be printed thereon, and includes a card made of paper, or plastic. The digital recording medium includes as a bar code or a non-volatile memory, and is not visually recognizable.

In the certificate transceiver system, the certificate receiver includes calculating means for generating a pattern of the certificate based on the received certificate identification information.

Since the calculating means generates the pattern of the certificate based on the certificate identification information in the certificate transceiver system, the amount of information transmitted from the certificate transmitter to the certificate receiver is reduced, and process time is shortened.

In the certificate transceiver system, the writing means writes substantially circular patterns, each having a diameter as a reading area limit of the reading means, spaced from each other by a distance of integer multiple of the diameters, and forms a pattern code representing a particular certificate identification information using the circular patterns. The reading means reads an area defined by each of the patterns spaced by a distance of an integer multiple of the diameters and reads the pattern code recorded on the certificate.

In the certificate transceiver system, the certificate identification information is identified by the pattern code, and the reading of the pattern code by the certificate transmitter and the writing of the pattern code by the certificate receiver are performed at the same precision. Since the reading pitch and the writing pitch for the pattern code identifying the certificate identification information precisely match each other, the counterfeiting of the certificate is prevented.

In certificate transceiver system, the recording medium preferably includes a non-volatile memory.

Since a new certificate is produced by writing the certificate information in the non-volatile memory in the certificate transceiver system, the counterfeiting of the certificate becomes difficult.

In the certificate transceiver system, the non-volatile memory may include a one-time PROM. The invalidating means may perform an overwrite process on the one-time PROM.

The one-time PROM is not reusable in the certificate transceiver system, because the overwrite process fuses entirely or partially the internal connection of the one-time PROM. This arrangement reliably prevents the original certificate from being reused.

In the certificate transceiver system, the non-volatile memory may be arranged in an IC chip. The IC chip, connected to an antenna, is embedded within the sheet of the certificate together with the antenna, and each of the invalidating means and the writing means gains access to the IC chip after each of the invalidating means and the writing means successfully completes an authentication process with the IC chip.

Since the certificate transmitter or the certificate receiver is authenticated, an unauthorized invalidating of the certificate and a counterfeiting of a new certificate are reliably prevented.

In the certificate transceiver system, the invalidating means may include printing means for printing invalidating information on the certificate.

In the certificate transceiver system, the printing means performs an overwrite process, printing the invalidating data on the original certificate. The invalided certificate is thus visually recognized, and is reliably revoked.

In the certificate transceiver system, the invalidating means may include shredding means for shredding the certificate.

Since the shredding means shreds the original certificate in the certificate transceiver system, the original certificate is reliably revoked.

In the certificate transceiver system, one of the certificate transmitter and the certificate receiver may include input means for inputting data to partially modify the certificate information to be written onto the recording medium. The certificate transmitter transmits the input data to the certificate receiver via a communication line.

The certificate receiver writes partially modifies the certificate information based on the data input by the operator before storing the certificate information to the recording medium in the certificate transceiver system. Information different from information on the original certificate can be written onto a new certificate.

The certificate transceiver system may include third communication means for communicating with one of the certificate transmitter and the certificate receiver, and a certificate transmission and reception management device including storage means for storing the certificate information, and certificate transmission and reception management processing means for receiving the certificate information from the certificate transmitter and storing the certificate information in the storage means, and transmitting the certificate information to the certificate receiver.

In the certificate transceiver system, the certificate management device transmits the certificate information, read from the original certificate by the certificate transmitter, to the certificate receiver, a new certificate is produced based on the certificate information received by the certificate receiver. The new certificate is thus issued based on the original certificate via the communication line. Since the certificate transmission and reception management device stores the received certificate information, the certificate transmitter can invalidate the original certificate immediately subsequent to the acknowledgement of the transmission of the certificate information. As a result, the unauthorized use of the original certificate is reliably prevented.

In the certificate transceiver system, the invalidating means may start invalidating the certificate when the certificate transmitter determines that the transmission of the certificate information to the certificate transmission and reception management device has been normally completed.

Since the original certificate is invalidated after the certificate information is normally transmitted to the certificate transmission and reception management device in the certificate transceiver system, the reliability of the issue of a new certificate is enhanced.

In the certificate transceiver system, the stored certificate information may be deleted when the certificate transmission and reception management device determines that the writing to the certificate receiver has been normally completed.

Since the stored certificate information is deleted in the certificate transceiver system after the production of the new certificate has been normally completed, the reliability of the issue of the new certificate is enhanced.

In the certificate transceiver system, the certificate transmission and reception management device may set, in the certificate information to be transmitted, replacement information stored beforehand in the storage means.

Since the certificate receiver writes the replacement information onto the recording medium in the certificate transceiver system, information different from the information of the original certificate is recorded onto the new certificate.

In the certificate transceiver system, the certificate transmitter may include input means for inputting transmission destination information for identifying the certificate receiver. The certificate transmitter transmits the input transmission destination information to the certificate transmission and reception management device. The certificate transmission and reception management device transmits the certificate information to the certificate receiver based on the received transmission destination information.

Since the certificate transmission and reception management device transmits the certificate information to the certificate receiver as the designated destination in the certificate transceiver system so that the certificate receiver may produce the new certificate. A customer may receive the new certificate at any desired location.

To overcome the previously-mentioned drawback, a certificate transmission and reception method of the present invention includes a step for examining whether or not the printing of the certificate is possible on a certificate receiver side, a step for reading certificate information recorded on an original certificate on a certificate transmitter side and transmitting the certificate information via a communication line if the printing of the certificate is possible on the certificate receiver side, a step for writing the received certificate information on a recording medium for the certificate on the certificate receiver side, and a step for invalidating the original certificate on the certificate transmitter side.

Since the certificate information is transmitted and then received only if the certificate information is can be printed on the certificate receiver side in the certificate transmission and reception method, the certificate information is reliably supplied to the certificate receiver side. A new certificate is thus produced and issued.

The certificate transmission and reception method further may include a step of the certificate receiver side for notifying the certificate transmitter side of the cause of a print impossible state based on the examination result if the examination result shows that the printing of the certificate is impossible.

Since the operator of the certificate receiver side is notified of the reason why the certificate cannot be printed in the transmission and reception method, the operator is able to take action in response, and the issue of a new certificate is smoothly performed.

The certificate transmission and reception method may further include a step of the certificate receiver side for notifying, via a communication line, the certificate transmitter side of the end of the writing to the recording medium. The certificate transmitter side starts an invalidating process at the moment the certificate transmitter side receives the end of the writing.

In the certificate transmission and reception method, the reliability of the issue of the new certificate is heightened because the original certificate is invalidated subsequent to the end of the production of the new certificate.

The certificate transmission and reception method may further include a step of checking whether or not the telephone number of a connection partner of the communication line is a registered telephone number, wherein a public telephone line on which the telephone number of the connection partner is acquired is used as the communication line. One of the transmission and the reception of the certificate information is performed if the check result shows that the telephone number is registered, and one of the transmission and the reception of the certificate information is not performed if the check result shows that the telephone number is not registered.

In the certificate transmission and reception method, the certificate information is transmitted to and received from an authentic connection partner by identifying the connection partner based on the telephone number. An unauthorized transmission and reception of the certificate information are prevented, and the certificate is protected from counterfeiting.

To achieve the previously described drawback, a certificate transmission and reception method includes a step of certificate transmitter side for reading certificate information recorded on a certificate and the invalidating the certificate, a relay step for receiving the certificate information from the certificate transmitter side, storing the certificate information, and transmitting the certificate information to a certificate receiver side, and a step of the certificate receiver side for writing the received certificate information onto a recording medium for the certificate, and horiginaling the recording medium.

Since the new certificate is produced beforehand and held in the certificate receiver side in the certificate transmission and reception method, a receiving person can get the certificate without waiting time for the writing to the recording medium.

The certificate transmission and reception method may include a step for notifying the certificate receiver side of certificate identification information of the certificate, and a step of the certificate receiver side for transferring the held recording medium to a user if certificate identification information input by the user matches the notified certificate information.

Since the authenticity of a receiving person is authenticated based on the certificate identification information, the reliability of the transfer is heightened.

To overcome the previously described drawback, a certificate transmission and reception method of the present invention includes a step of a certificate transmitter side for reading certificate information recorded onto a certificate and invalidating the certificate, a relay step for receiving and then storing the certificate information from the certificate transmitter side, and transmitting the certificate information to a certificate receiver side, a step of the certificate receiver side for storing the received certificate, a step for notifying the certificate receiver side of certificate identification information of the certificate, and a step of the certificate receiver side for writing the stored certificate information onto a recording medium and transferring the recording medium to a user if certificate identification information input by the user matches the notified certificate identification information.

No new horiginaling space is required (for the new certificate) because the certificate receiver side stores the received certificate information and writes the certificate information on the recording medium at the time of delivery. Since the certificate prior to delivery is stored as the certificate information, the certificate receiver side accepts the issue of a large number of tickets to be delivered.

In the certificate transmission and reception method, the relay step may include authenticating the certificate.

Since the original certificate is authenticated, an unauthorized new ticket is prevented from being issued.

In the certificate transmission and reception method, the certificate identification information is preferably recorded onto the certificate.

Since the certificate transmitter side scans the original certificate to read the certificate identification information to notify the certificate receiver side of the certificate identification information, the management of the certificate identification information is facilitated.

The certificate transmitter in the present invention corresponds to a certificate transceiver on a stock certificate receiver side, or a certificate receiver 1 on a ticket receiver side. The certificate transmission and reception management device corresponds to a management server 2, a database 3, or a database 41.

In accordance with the present invention, certificates of value include securities (such as stock certificates, credits, exchange coupons, etc.), audience tickets (for music, drama, sports events, etc.), and transportation tickets (airline tickets, railway tickets, etc.).

### BRIEF DESCRIPTION OF THE DRAWINGS

FIG. 1 is a block diagram illustrating the structure of a certificate transceiver system in accordance with the present invention.

FIG. 2 is a block diagram illustrating the structure of a certificate transceiver used in the certificate transceiver system in accordance with a first embodiment of the present invention.

FIG. 3 is a block diagram illustrating the mechanism in the certificate transceiver of FIG. 2 for scanning and writing information.

FIG. 4 illustrates a stock certificate handled in the first embodiment of the present invention.

FIG. 5 is a first sequence chart illustrating the process flow of a certificate reception process performed by the certificate transceiver system of FIG. 1.

FIG. 6 is a second sequence chart illustrating the process flow of a certificate reception process performed by the certificate transceiver system of FIG. 1.

FIG. 7 is a block diagram illustrating the structure of a certificate transceiver in a certificate transceiver system in accordance with a second embodiment of the present invention.

FIG. 8 illustrates a stock certificate handed in the second embodiment.

FIG. 9 illustrates a pattern code of FIG. 8.

FIG. 10 is a block diagram illustrating the structure of a certificate transceiver in a certificate transceiver system in accordance with a third embodiment of the present invention.

FIG. 11 illustrates a stock certificate handled in the third embodiment of the present invention.

FIG. 12 is a block diagram illustrating the structure of an IC chip reader and writer of FIG. 10.

FIG. 13 is a block diagram illustrating the structure of another certificate transceiver system in accordance with the present invention.

FIG. 14 is a block diagram illustrating the structure of a management server for use in the certificate transceiver system in accordance with the present invention.

FIG. 15 illustrates a stock certificate management table stored in a database of FIG. 13.

FIG. 16 is a sequence chart illustrating the process flow of a certificate reception process performed by the certificate transceiver system of FIG. 13.

FIG. 17 is a block diagram illustrating the structure of another certificate transceiver system in accordance with the present invention.

FIG. 18 illustrates a communication address management table stored in the database of FIG. 17.

FIG. 19 illustrates a ticket management table stored in the database of FIG. 17.

FIG. 20 is a sequence chart illustrating the process flow of a certificate reception process performed by the certificate transceiver system of FIG. 17.

### BEST MODE FOR CARRYING OUT THE INVENTION

The embodiments of the present invention are described below with reference to the drawings. In one embodiment, a specific example of certificate of value is a stock certificate as one of securities. A certificate transceiver system a transfer agent uses to transmit and receive stock certificate data is described.

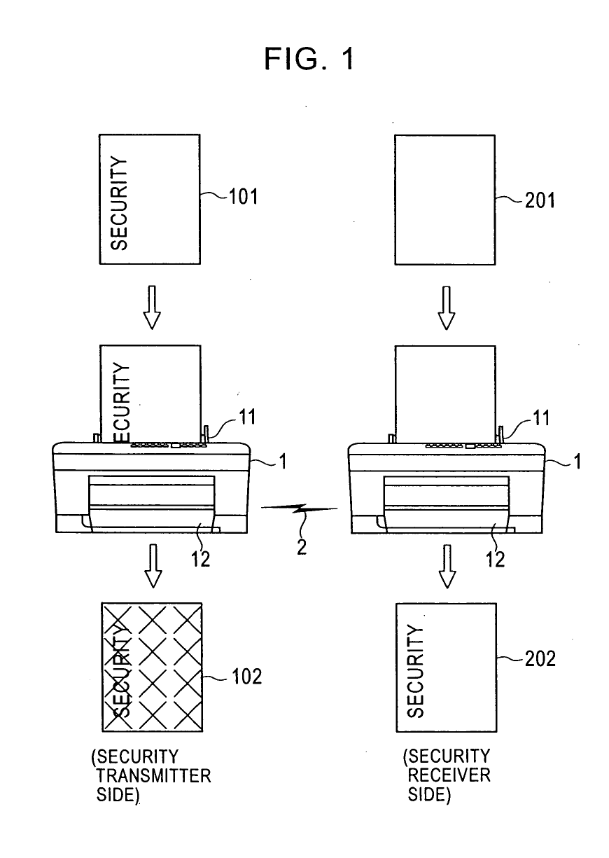

FIG. 1 illustrates the certificate transceiver system of the present invention. The certificate transceiver system includes a certificate transceiver 1 on a stock certificate transmitter side, and a certificate transceiver 1 on a stock certificate receiver side. The certificate transceivers 1 are connected via a communication line 2, such as the Internet, and exchange data with each other. The certificate transceiver systems in accordance with first through third embodiments of the present invention are described in that order below.

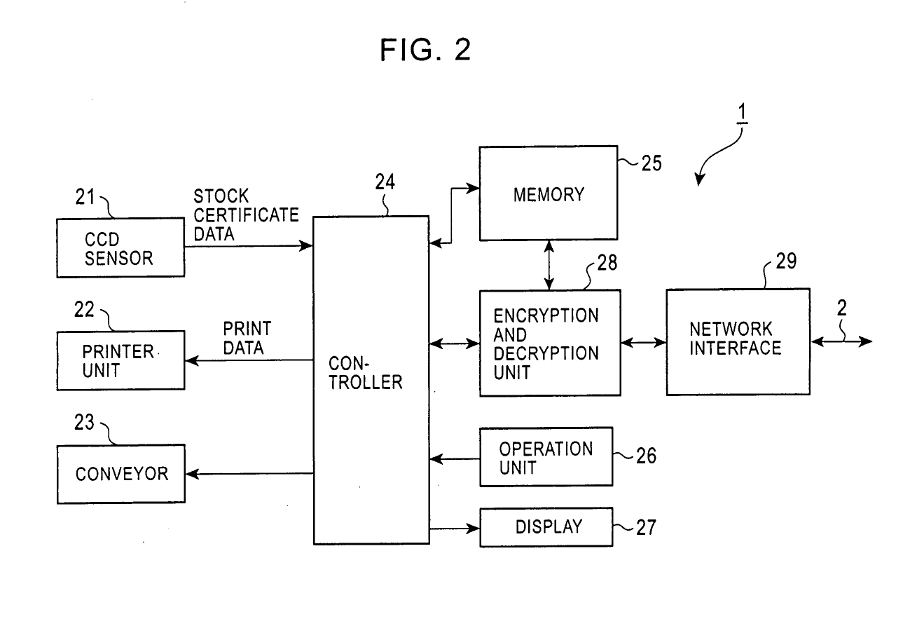

FIG. 2 illustrates the certificate transceiver 1 of FIG. 1 in accordance with the first embodiment. As shown in FIG. 2, a CCD sensor 21, arranged in a certificate input port 11 shown in FIG. 1, optically scans an original stock certificate 101 to read stock certificate information thereof received into the certificate input port 11. Stock certificate data is thus output from the CCD sensor 21.

A printer unit 22, arranged at a certificate output port 12, prints invalidating information on the stock certificate 101 or certificate information on a stock certificate sheet 201, each input through the certificate input port 11, in accordance with input print data. The printer unit 22 can print characters and patterns. The original stock certificate 101 after printing (invalidated stock certificate 102) or the stock certificate sheet 201 after printing (new stock certificate 202) is discharged from the certificate output port 12.

A conveyor 23 conveys the stock certificate 101 or the stock certificate sheet 201 set in the certificate input port 11 from the certificate input port 11 to the certificate output port 12.

A controller 24 controls the elements of the certificate transceiver 1. The controller 24 accesses a memory 25, thereby reading data therefrom and writing data thereto. The controller 24 receives stock certificate data of the stock certificate 101 received from the CCD sensor 21, and then transmits the stock certificate data to the certificate transceiver 1 on the stock certificate receiver side. To invalidate the stock certificate 101, the controller 24 outputs print data as invalidating information to the printer unit 22, thereby causing the printer unit 22 to print the print data on the stock certificate 101 for overwriting. The invalidating information may include characters, symbols, and patterns. For example, reference numeral 102 of FIG. 1 shows that a symbol “x” overwrites the stock certificate 101, and the stock certificate is thus invalidated.

The controller 24 on the stock certificate receiver side outputs the print data to the printer unit 22 in accordance with the stock certificate data received from the certificate transceiver 1 on the stock certificate transmitter side, and causes the printer unit 22 to print the stock certificate information onto the stock certificate sheet 201. The new stock certificate 202 thus results.

An operation unit 26 includes character input keys, a variety of function keys, and an input control circuit. The operation unit 26 thus receives character inputting, and a variety of operational inputs to the certificate transceiver 1. Data input to the operation unit 26 is output to the controller 24. The controller 24 performs print processes and control processes in response to the data input thereto. In this way, the name of a new stock holder is input and printed on a certificate sheet as a new stock certificate.

A display 27 includes a liquid-crystal display panel and a display control circuit, and displays presentation data received from the controller 24.

An encryption and decryption unit 28 encrypts the stock certificate data to be transmitted to the certificate transceiver 1 on the stock certificate receiver side. The encryption and decryption unit 28 decrypts encrypted stock certificate data received from the certificate transceiver 1 on the stock certificate transmitter side. The encryption and decryption unit 27 on the stock certificate transmitter side stores the encrypted stock certificate data onto the controller 24 for re-transmission. The stored stock certificate data is deleted after the certificate transceiver 1 on the stock certificate receiver side has completed the printing of the new stock certificate.

A network interface 29 establishes a communication line 2 with the certificate transceiver 1 on the communication partner, and exchanges data with the certificate transceiver 1 on the communication partner via the communication line 2.

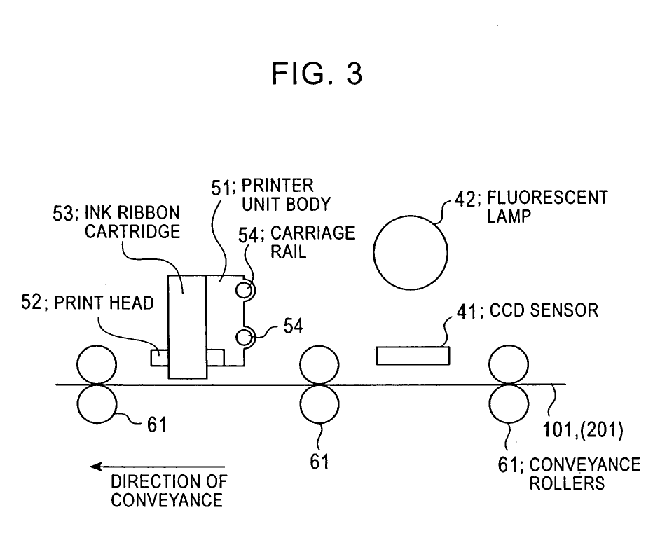

FIG. 3 illustrates a mechanism for scanning and writing information, including the CCD sensor 21, the printer unit 22, and the conveyor 23. The CCD sensor 21 include a CCD sensor element 41 for optically scanning the stock certificate to read information therefrom, and a fluorescent lamp 42 serving as a light source for the CCD sensor element 41 in the scanning operation. The printer unit 22 includes a printer unit body 51 including a print head control circuit, a driving motor for moving the print head in a print direction, etc., the print head 52 for printing print data on a recording medium (such as the stock certificate 101 or the stock certificate sheet 201), a ink ribbon cartridge 53 for feeding ink to the print head 52, and a carriage rail 54 for guiding the printer unit body 51 in the print direction. The print head 52 and the ink ribbon cartridge 53 are secured to the printer unit body 51. The conveyor 23 includes a plurality of conveyance rollers 61 for conveying one of the stock certificate 101 and the stock certificate sheet 201 from the certificate input port 11 to the certificate output port 12.

While the stock certificate 101 is conveyed from the certificate input port 11 to the certificate output port 12 by the conveyor 23 as shown in FIG. 3, the CCD sensor 21 optically scans the stock certificate 101 to read the stock certificate information, and then, the printer unit 22 prints invalidating information onto the stock certificate 101 in accordance with print data. While the stock certificate sheet 201 is conveyed from the certificate input port 11 to the certificate output port 12 by the conveyor 23, the printer unit 22 pints the stock certificate information onto the stock certificate sheet 201 in accordance with the print data.

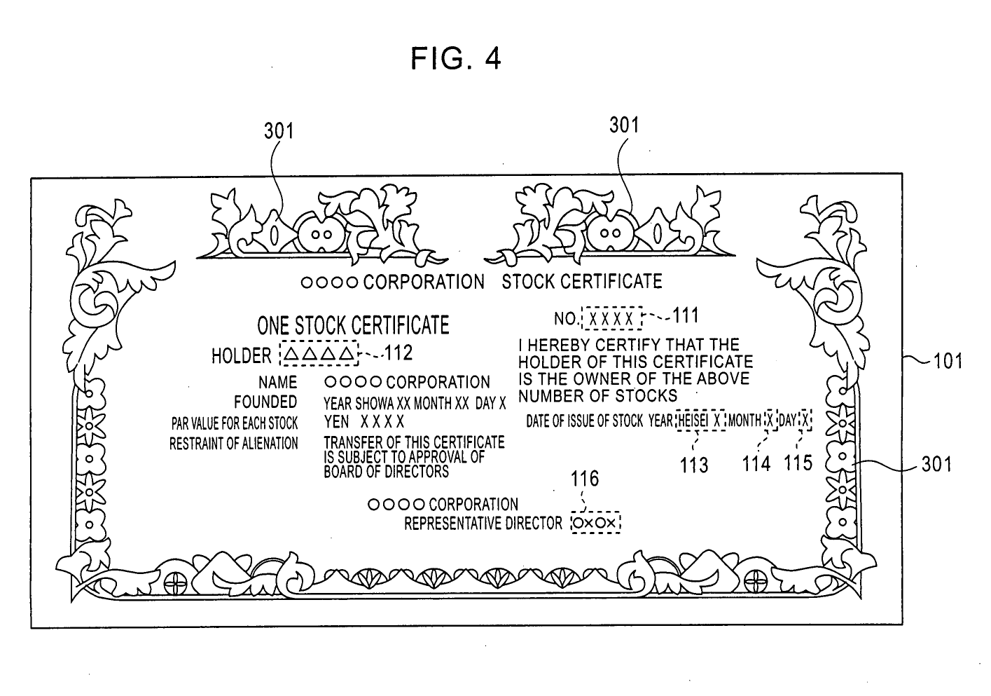

FIG. 4 illustrates the stock certificate 101. As shown in FIG. 4, the stock certificate information including characters and a pattern 301 is printed onto the stock certificate 101.

As shown in FIG. 4, information recorded in broken-line boxes 111-116 at predetermined locations is variable stock certificate information that can be updated at the transfer of the name of the holder. A stock certificate number is printed in the box 111, the name of the holder (nominal person) of the stock is printed in the box 112, the year, month, and date of the issue of the stock certificate are printed in the boxes 113-115, and the representative director (of the issuer of the stock certificate) is printed in the box 116.

The CCD sensor 21 optically scans the stock certificate 101, thereby outputting read information as the stock certificate data. The boxes 111-116 are excluded from the read data, and the information printed in the boxes 111-116 is not contained in the stock certificate data. The stock certificate data thus includes the stock certificate information excluding the information in the boxes 111-116. The information other than in the boxes 111-1116 (namely, the characters including the company's name, and the pattern 301) is fixed stock certificate information and not updated at the transfer of the holder name.

The operation of the certificate transceiver system of FIG. 1 is described below.

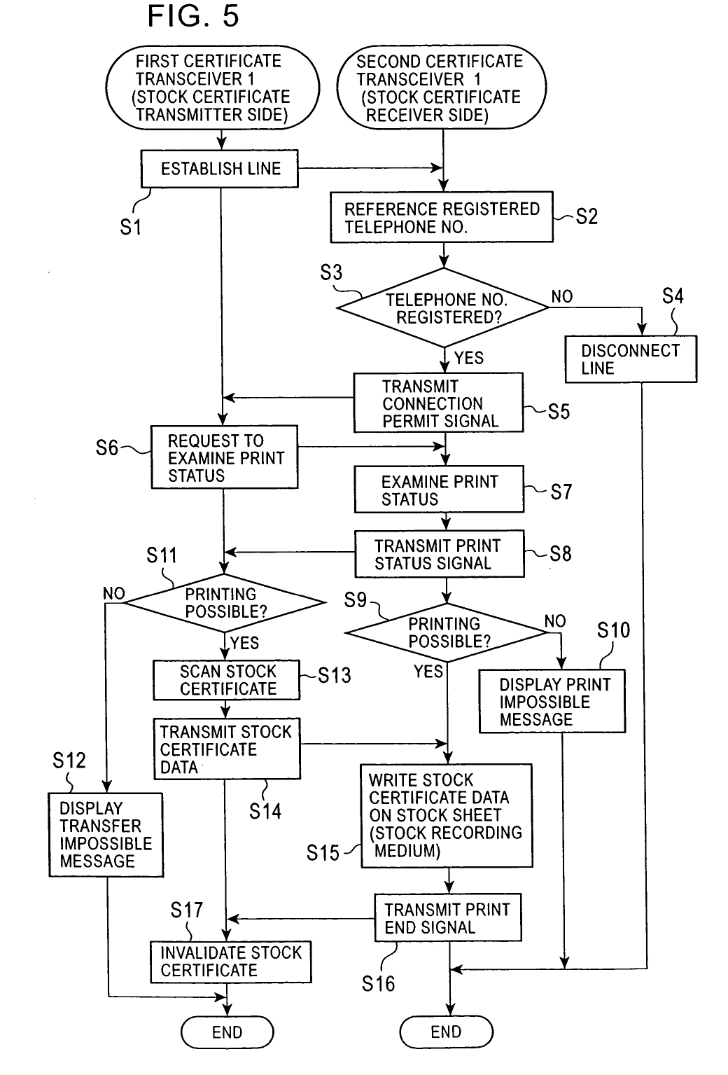

The start process of the transmission of the stock certificate information from the stock certificate transmitter side is described with reference to a sequence chart of FIG. 5. As shown in FIG. 5, the operator sets the original stock certificate 101 in the certificate input port 11 of the certificate transceiver 1 on the stock certificate transmitter side subsequent to the conclusion of a stock transfer contract. The operator issues an instruction to transmit the certificate. In response to the instruction, the controller 24 in the certificate transceiver 1 on the stock certificate transmitter side establishes the communication line 2 with the certificate transceiver 1 on the stock certificate receiver side via the network interface 29 (step S1).

In the certificate transceiver 1 on the stock certificate receiver side, the controller 24 references telephone numbers registered in the memory 25 to determine whether the telephone number of a communication partner is registered (steps S2 and S3). If the telephone number of the communication partner is unregistered, the controller 24 disconnects the line, and ends processing (step S4). If the telephone number of the communication partner is registered, the controller 24 transmits a connection permit signal to the certificate transceiver 1 on the stock certificate transmitter side (step S5).

The controller 24 in the certificate transceiver 1 on the stock certificate transmitter side requests the certificate transceiver 1 on the certificate transceiver 1 on the stock certificate receiver side to examine print status (step S6). Upon receiving the request, the controller 24 on the stock certificate receiver side checks that the printer unit 22 of own apparatus is ready to print (free from problems such as out of ink), and that the stock certificate sheet 201 is set in the certificate input port 11 (step S7).

If all settings are correctly complete, the controller 24 determines that the stock receiver side is in a print possible state, and transmits a print status signal indicating the print possible state to the certificate transceiver 1 on the stock certificate transmitter side. If all settings are not correctly complete, the controller 24 determines the stock receiver side is in a print impossible state, and transits a print status signal indicating a print impossible state to the certificate transceiver 1 on the stock certificate transmitter side (step S8). If the status is in a print impossible state, the controller 24 displays a print impossible message, and ends processing (steps S9 and S10).

If the stock certificate receiver side is in a print impossible state, the controller 24 in the stock certificate transmitter side displays a transfer impossible message in response to the received print status signal and ends processing (steps S11 and S12). If the stock certificate receiver side is in a print possible state, the controller 24 starts the scanning operation to read the stock certificate information from the stock certificate 101 set in the certificate input port 11. The CCD sensor 21 thus scans the stock certificate 101 to read the stock certificate information, and outputs the stock certificate information as the stock certificate data to the controller 24 (step S13).

The controller 24 transmits the stock certificate data to the certificate transceiver 1 on the stock certificate receiver side. The stock certificate data is encrypted by the encryption and decryption unit 28 before being transmitted. The encryption and decryption unit 28 store the encrypted stock certificate data in the memory 25 (step S14).

In the certificate transceiver 1 on the stock certificate receiver side, the controller 24 outputs, to the printer unit 22, print data in response to the received stock certificate data (the stock certificate data already decrypted by the encryption and decryption unit 28), thereby causing the printer unit 22 to print the stock certificate information onto the stock certificate sheet 201 (certificate (image) recording medium). In this way, the stock certificate information of the original stock certificate 101 is printed on the stock certificate sheet 201 by the printer unit 22, and the new stock certificate 202 is discharged from the certificate output port 12 (step S16). If this writing operation is complete, the controller 24 transmits a print end signal to the certificate transceiver 1 on the stock certificate transmitter side (step S16).

Upon receiving the print end signal, the controller 24 on the stock certificate transmitter side outputs print data for invalidating the stock certificate 101 to the printer unit 22. In this way, the printer unit 22 prints the invalidating information on the stock certificate 101 in an overwrite process, and the invalidated stock certificate 102 is discharged from the certificate output port 12. The controller 24 deletes the stock certificate data from the memory 25 (step S17).

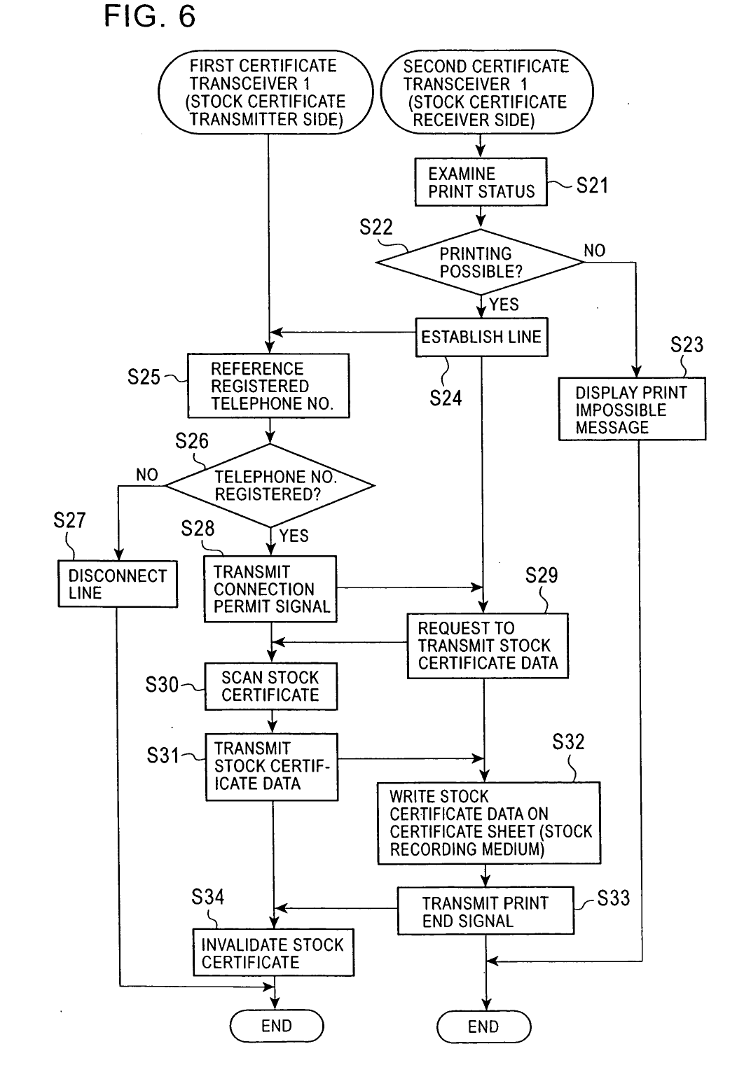

A request process to transmit the stock certificate information from the stock certificate receiver side is described with reference to a sequence chart of FIG. 6. As shown in FIG. 6, in response to an instruction from the operation subsequent to the conclusion of a transfer contract of a stock, the controller 24 in the certificate transceiver 1 on the stock certificate receiver side checks that the printer unit 22 of own apparatus is ready to print, and that the stock certificate sheet 201 is set in the certificate input port 11 (step S21).

If all settings are correctly complete, the controller 24 determines that the stock certificate receiver side is in a print possible state, and then establishes the communication line 2 with the certificate transceiver 1 on the stock certificate transmitter side via the network interface 29 (steps S22 and S24). If all settings are not correctly complete, the controller 24 determines that the stock certificate receiver side is in a print impossible state, and displays a print impossible message, and ends processing (step S23).

In the certificate transceiver 1 on the stock certificate transmitter side, the controller 24 references telephone numbers registered in the memory 25, and determines whether a telephone number of the communication partner is registered (steps S25 and S26). If the telephone number of the communication partner is unregistered, the controller 24 disconnects the line and ends processing (step S27). If the telephone number of the communication partner is registered, the controller 24 transmits a connection permit signal to the certificate transceiver 1 on the stock certificate receiver side (step S28).

Upon receiving the connection permit signal, the controller 24 in the certificate transceiver 1 on the stock certificate receiver side requests the certificate transceiver 1 on the stock certificate transmitter side to transmit stock certificate data (step S29). In response, the controller 24 on the stock certificate transmitter side reads the stock certificate information of the stock certificate 101 and transmits the stock certificate information to the certificate transceiver 1 on the stock certificate receiver side (steps S30 and S31) in a similar manner as in steps S13 and S14 of FIG. 5.

In succession, a process similar to steps S15-S17 of FIG. 5 is performed. In the certificate transceiver 1 on the stock certificate receiver side, the new stock certificate 202 having the stock certificate information of the original stock certificate 101 printed thereon is discharged from the certificate output port 12. In the certificate transceiver 1 on the stock certificate receiver side, the stock certificate 101 is invalidated, and the stock certificate data is deleted from the memory 25 (steps S32-S34).

In accordance with the above-referenced first embodiment, the certificate transceiver 1 on the stock certificate transmitter side reads the stock certificate information from the original stock certificate, and transmits the stock certificate information to the certificate transceiver 1 on the stock certificate receiver side via the communication line, and the certificate transceiver 1 on the stock certificate receiver side produces the new stock certificate from the received stock certificate information. The new certificate is thus issued via the communication line based on the original stock certificate. Since the certificate transceiver 1 on the stock certificate transmitter side invalidates the original stock certificate, an unauthorized use of the original stock certificate is prevented.

Since the certificate transceiver 1 on the stock certificate transmitter side starts validating the original stock certificate on condition that the print end signal has been received from the certificate transceiver 1 on the stock certificate receiver side, the original stock certificate is validated subsequent to the completion of the production of the new stock certificate. In this way, the reliability of the issue of the new stock certificate is heightened.

In step S10, the certificate transceiver 1 may display the cause for a print impossible state based on the examination result of the print status. The operator thus learns the cause of the print impossible state (such as a out of ink), and can take action to solve the problem.

In the certificate transceiver 1 on the stock certificate receiver side, the operator uses the operation unit 26 to enter variable stock certificate information (such as the name of a new holder) to be recorded in the boxes 111-116 of the new stock certificate 202. In step S15, the stock certificate information is written onto the stock certificate sheet 201. Alternatively, the certificate transceiver 1 may include a data input device (such as a reading device for reading a recording medium (such as a flexible disk)), and the data input device may input information to be recorded in the boxes 111-1116 via a communication line. Alternatively, the information may be input via a communication line through the network interface 29. In this case, the operator of the certificate transceiver 1 on the stock certificate transmitter side inputs, on the operation unit 26 of the certificate transceiver 1 on the stock certificate transmitter side, the information to be recorded in the boxes 111-116 of the new stock certificate 202, and then transmits the information to the certificate transceiver 1 on the stock certificate receiver side via the communication line 2.

The certificate transceiver 1 on the stock certificate transmitter side may the variable stock certificate information in the boxes 111-116 and transmits the variable stock certificate information to the certificate transceiver 1 on the stock certificate receiver side, and the certificate transceiver 1 on the stock certificate receiver side may select the variable stock certificate information to be written onto the new stock certificate 201.

The invalidating method of invalidating the stock certificate may be any method other than the overwriting of the stock certificate 101 with the invalidating information. For example, the certificate transceiver 1 may include a shredder, and the original stock certificate may be shredded using the shredder.

As shown in FIG. 1, the certificate transceiver 1 on the stock certificate transmitter side may be connected via a communication line to the management server that manages the transfer of the name of the stock and the issue of the stock, and the management server may then be notified that the new stock certificate 202 has been issued, and that the original stock certificate 101 is invalidated. This notification to the management server may be performed by the certificate transceiver 1 on the stock certificate receiver side subsequent to step S15 of FIG. 5.

The certificate transceiver 1 on the stock certificate transmitter side may be connected via a communication line to a database server for storing data of updated names of the holder, acquire the updated holder name data, and include the updated holder name data in the stock certificate data to be transmitted to the certificate transceiver 1 on the stock certificate receiver side. Alternatively, the certificate transceiver 1 on the stock certificate receiver side may acquires the updated holder name data from the database server via the communication line, and write the data onto the new stock certificate.

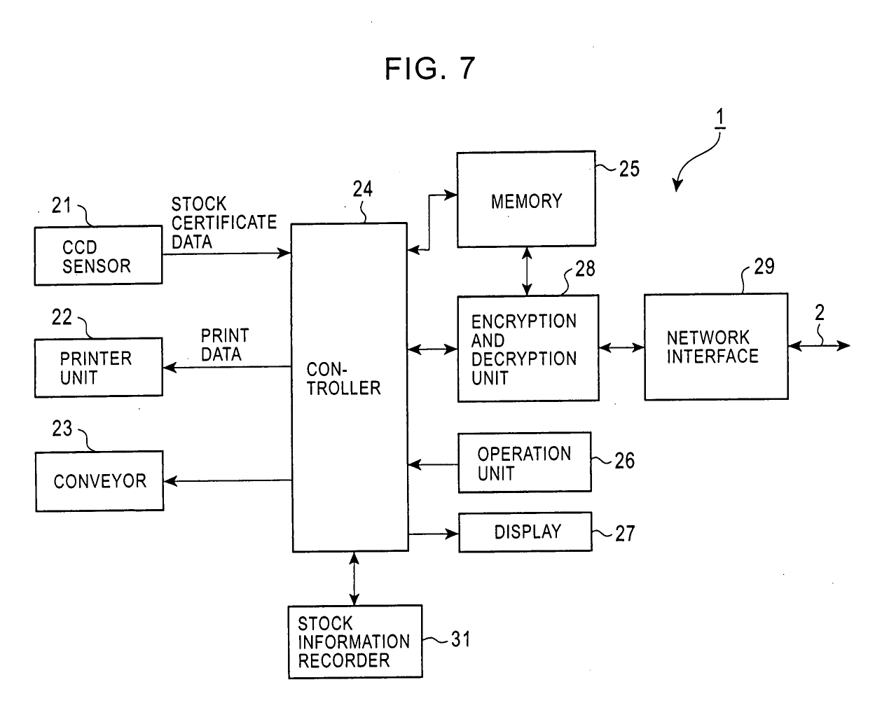

A stock certificate transmission and reception system in accordance with a second embodiment of the present invention is described below. FIG. 7 illustrates the structure of the certificate transceiver 1 in accordance with the second embodiment of the present invention. As shown in FIG. 7, elements identical to those illustrated in FIG. 2 are designated with the same reference numerals and the discussion thereof is omitted. The certificate transceiver 1 of the second embodiment includes a stock information recorder 31 as shown in FIG. 7. The stock information recorder 31 records at least fixed information, out of the stock certificate information recorded onto the stock certificate 101, with the stock certificate identification information for identifying the stock associated with the fixed information. The fixed information of the stock certificate information refers to “information that is not updated at the transfer of the holder name” as discussed with reference to FIG. 4.

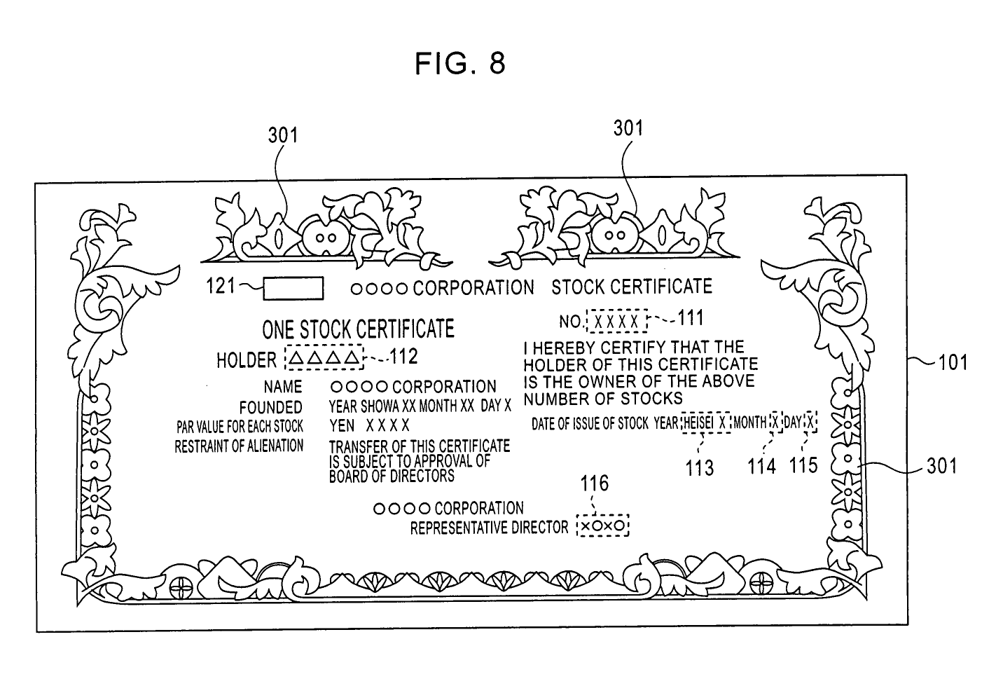

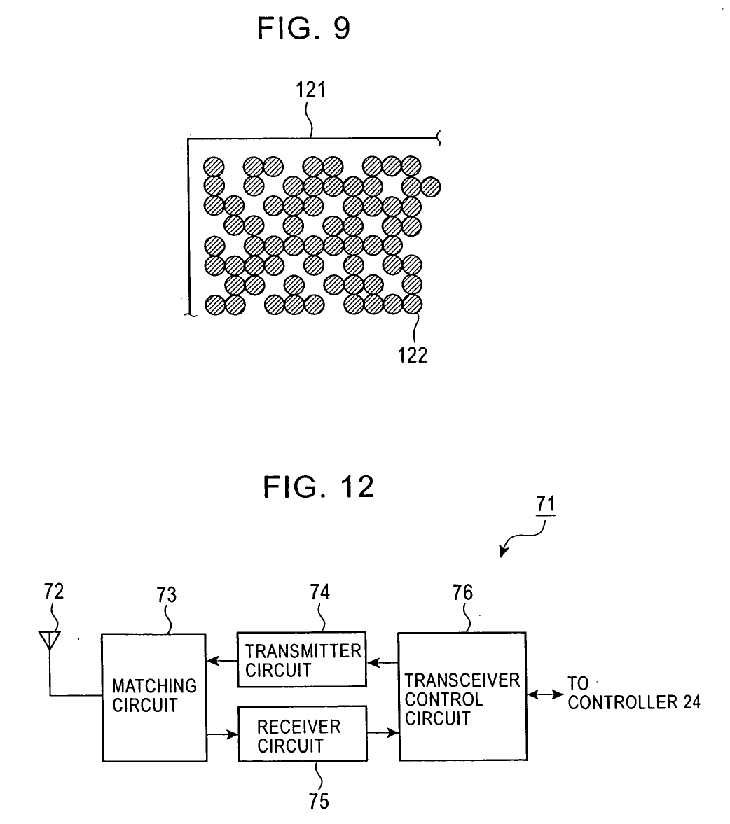

In accordance with the second embodiment, the original stock certificate 101 has the stock certificate identification information printed thereon. As shown in FIG. 8, for example, a pattern code 121 representing particular stock certificate identification information is recorded in a predetermined location on the stock certificate 101. FIG. 9 illustrates the pattern code 121. As shown in FIG. 9, the pattern code 121 includes a plurality circular patterns 122. The pattern 122 has a diameter the CCD sensor element 41 can discriminates at the highest resolution limit value thereof. The CCD sensor element 41 is able scan the area of the patterns 122 spaced apart by an integer multiple of the diameters. The print head 52 of FIG. 3 is able to write the patterns 122 spaced apart by an integer multiple of the patterns 122.

In this way, the reading pitch and the writing pitch of the pattern code 121 are precisely set to be equal to each other. In this arrangement, the pattern code 121, namely, the stock certificate is difficult to counterfeit.

The form of the stock certificate identification information is not limited to the pattern code. Alternatively, the stock certificate identification information may be a bar code, or characters and symbols of the stock certificate identification information may be used for identification.

The CCD sensor 21 may the stock certificate 101 to read the fixed stock certificate information and the stock certificate identification information, and read stock certificate information and stock certificate identification information may be recorded in the stock information recorder 31. Alternatively, the certificate transceiver 1 may include a data input device (such as a reading device for reading a recording medium (such as a flexible disk)), and the data input device may input the fixed stock certificate information and the stock certificate identification information. Alternatively, the fixed stock certificate information and the stock certificate identification information may be input via a communication line through the network interface 29.

The stock information recorder 31 may be contained in a device (a database server) external to the certificate transceiver 1, and the certificate transceiver 1 may gain access to the stock information recorder 31 through communication.

In accordance with the second embodiment, the CCD sensor 21 in the certificate transceiver 1 on the stock certificate transmitter side scans the stock certificate 101 to read the stock certificate identification information, and the read stock certificate identification information is transmitted to the certificate transceiver 1 on the stock certificate receiver side as the stock certificate data. In response to the stock certificate identification information of the received the stock certificate data, the certificate transceiver 1 on the stock certificate receiver side reads the stock certificate information from the stock information recorder 31, and causes the printer unit 22 to print the stock certificate information and the stock certificate identification information on the stock certificate sheet 201 to produce the new stock certificate 202. The certificate transceiver 1 on the stock certificate transmitter side invalidates the original stock certificate 101 by printing the invalidating information on the stock certificate 101 in an overwrite fashion as in the first embodiment. During invalidating, information is printed on a record portion (such as the pattern code 121) of the stock certificate identification information for invalidating so that the stock certificate identification information cannot be precisely read.

In accordance with the second embodiment, as in the first embodiment, the new stock certificate is issued via the communication line in accordance with the original stock certificate, and an unauthorized use of the original stock certificate is prevented. The stock certificate data to be transmitted from the stock certificate transmitter side to the stock certificate receiver side is only data of the stock certificate identification information. The amount of information transmitted from the stock certificate transmitter side to the stock certificate receiver side is thus reduced, and process time is shortened.

The certificate transceiver 1 may include a calculating device for generating the pattern 301 based on the stock certificate identification information received from the stock certificate transmitter side. For example, the calculating device may include a memory having stored design data for reproducing the pattern 301, and a calculating and processing unit for generating the pattern 301 based on the design data. Even in this arrangement, the stock certificate data to be transmitted from the stock certificate transmitter side to the stock certificate receiver side is only data of the stock certificate identification information. The amount of information transmitted from the stock certificate transmitter side to the stock certificate receiver side is thus reduced. The data to be recorded for the production of the pattern 301 is the pattern 301 not in image data form thereof but in a compression encoded form thereof. The amount of data to be recorded as the pattern 301 is reduced, and the capacity of memory is thus reduced.

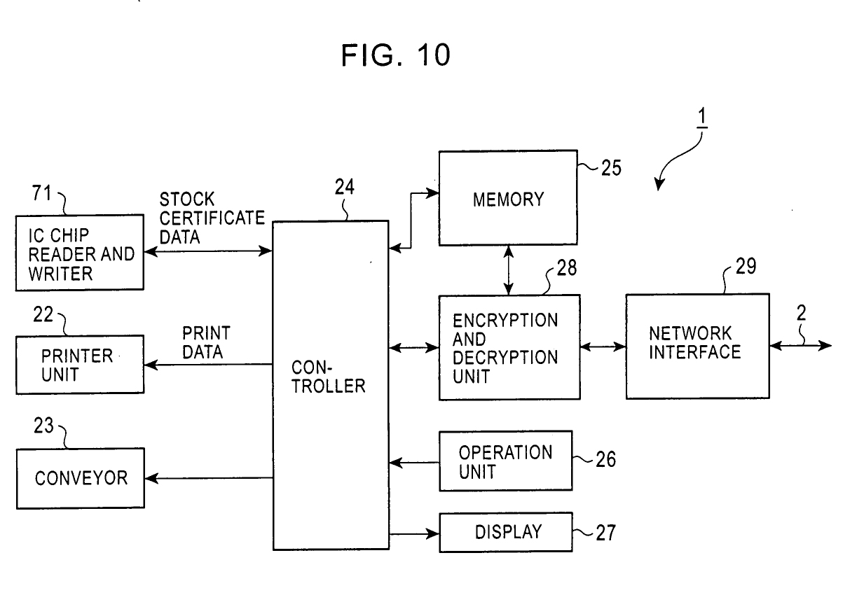

A certificate transceiver system in accordance with a third embodiment of the present invention is described below. FIG. 10 illustrates the structure of the certificate transceiver 1 of the third embodiment. As shown in FIG. 10, elements identical to those illustrated in FIG. 2 are designated with the same reference numerals, and the discussion thereof is omitted here. The certificate transceiver 1 of the third embodiment includes a IC chip reader and writer 71 instead of the CCD sensor 21 as shown in FIG. 10.

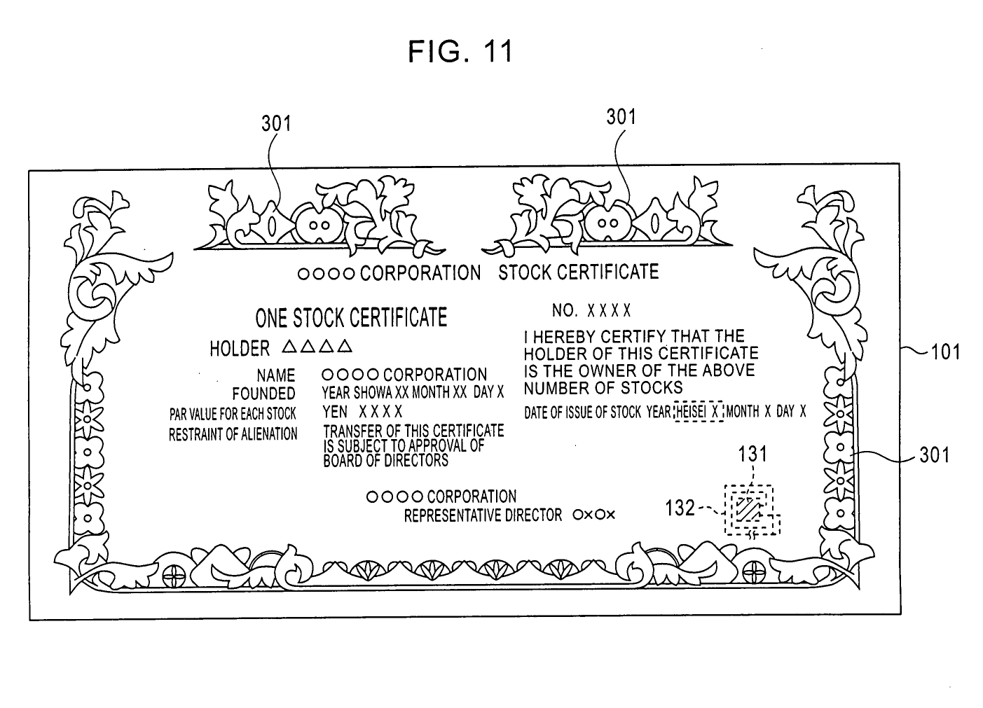

In accordance with the third embodiment, the stock certificate sheet 201 includes an IC chip connected to an antenna for performing a contactless read and write operation. For example, as shown in FIG. 11, an IC chip 131 and an IC chip 132 connected thereto are embedded within the stock certificate 101. The IC chip 131 includes an erasable non-volatile memory, such as an EEPROM, and a microprocessor, and receives an access from the IC chip reader and writer 71 that has been identified as being authentic. Alternatively, the stock information recorder 31 may include an unerasable non-volatile memory (one-time PROM) and a memory access circuit.

As shown in FIG. 10, the non-volatile memory in the IC chip 131 stores data of at least fixed stock certificate information (the characters of the name of the corporation and the pattern 301) out of the stock certificate information printed on the stock certificate 101. The stock certificate information that is fixed and unupdated regardless of the transfer of the holder name is thus reproduced based on the data.

FIG. 12 illustrates the structure of the IC chip reader and writer 71 of FIG. 11. The IC chip reader and writer 71 includes an antenna 72 electromagnetically coupled with the antenna 132 connected to the IC chip 131 of the stock certificate 101, a matching circuit 73 for performing impedance matching to achieve optimum electromagnetic coupling between the stock certificate 101 and the antenna 72, a transmitter circuit 74 for transmitting data to the IC chip 131, a receiver circuit 75 for receiving data from the IC chip 131, and a transceiver control circuit 76 for performing transmission and reception control to perform ASK (Amplitude Shift Keying) time-division two-way communication. The IC chip reader and writer 71 gains access to the IC chip 131 in a contactless fashion to read data from and write data to the IC chip 131. The transceiver control circuit 76 exchanges data with the controller 24 of FIG. 10.

In accordance with third embodiment, the IC chip reader and writer 71 in the certificate transceiver 1 on the stock certificate transmitter side reads the stock certificate information from the IC chip 131 of the original stock certificate 101. The read stock certificate information is transmitted to the certificate transceiver 1 on the stock certificate receiver side as the stock certificate data. The certificate transceiver 1 on the stock certificate receiver side writes the stock certificate information of the received stock certificate data onto the IC chip 131 of the stock certificate sheet 201 with the IC chip reader and writer 71. The printer unit 22 prints the stock certificate data onto the stock certificate sheet 201, thereby producing the new stock certificate 202. The certificate transceiver 1 on the stock certificate transmitter side invalidates the stock certificate 101 by printing the invalidating information in an overwrite process as in the first embodiment. During invalidating, the IC chip reader and writer 71 writes invalidating information over the IC chip 131 of the original stock certificate 101, thereby making the stock certificate information in the IC chip 131 invalid.

If the non-volatile memory in the IC chip 131 is a one-time PROM, recorded data is entirely erased by fusing an internal connection such as fuse or a circuit prepared in the one-time PROM to an electrically open state so that the one-time PROM is used no longer. To prevent re-use, the internal connection may be partially fused to an open circuit. An overwrite process for entirely or partially fusing the internal connection of the one-time PROM for open circuit prevents the original stock certificate from being re-used, without the need for the printer unit 22 to write the invalidating information over the original stock certificate.

As in the first embodiment, the stock certificate receiver side inputs variable stock certificate information that is updated at the transfer of the holder name, and writes the updated stock certificate information on the stock certificate sheet 201. The writing of the variable stock certificate information on the IC chip 131 of the stock certificate sheet 201 is preferable to prevent the counterfeiting of the stock certificate.

If the variable stock certificate information is recorded in the IC chip 131 of the stock certificate 101, the stock certificate transmitter side reads the variable stock certificate information and transmits the information to the stock certificate receiver side. The stock certificate receiver side selects the variable stock certificate information to be written onto the stock certificate sheet 201 and the IC chip 131.

In accordance with the third embodiment, only the stock certificate identification information may be written onto the non-volatile memory in the IC chip 131. In this case, in the same manner as in the second embodiment, the stock certificate transmitter side transmits only the stock certificate identification information to the stock certificate receiver side, and the stock certificate receiver side acquires the stock certificate information (such as characters and patterns) based on the received stock certificate identification information.

In accordance with the third embodiment, as in the first embodiment, the new stock certificate is issued via the communication line in accordance with the original stock certificate, and an unauthorized use of the original stock certificate is prevented. Since the IC chip is used as a recording medium of the stock certificate, the counterfeiting of the stock certificate becomes more difficult. Since the invalidating information is printed on the original stock certificate, the invalidated stock certificate information in the IC chip is visibly recognized.

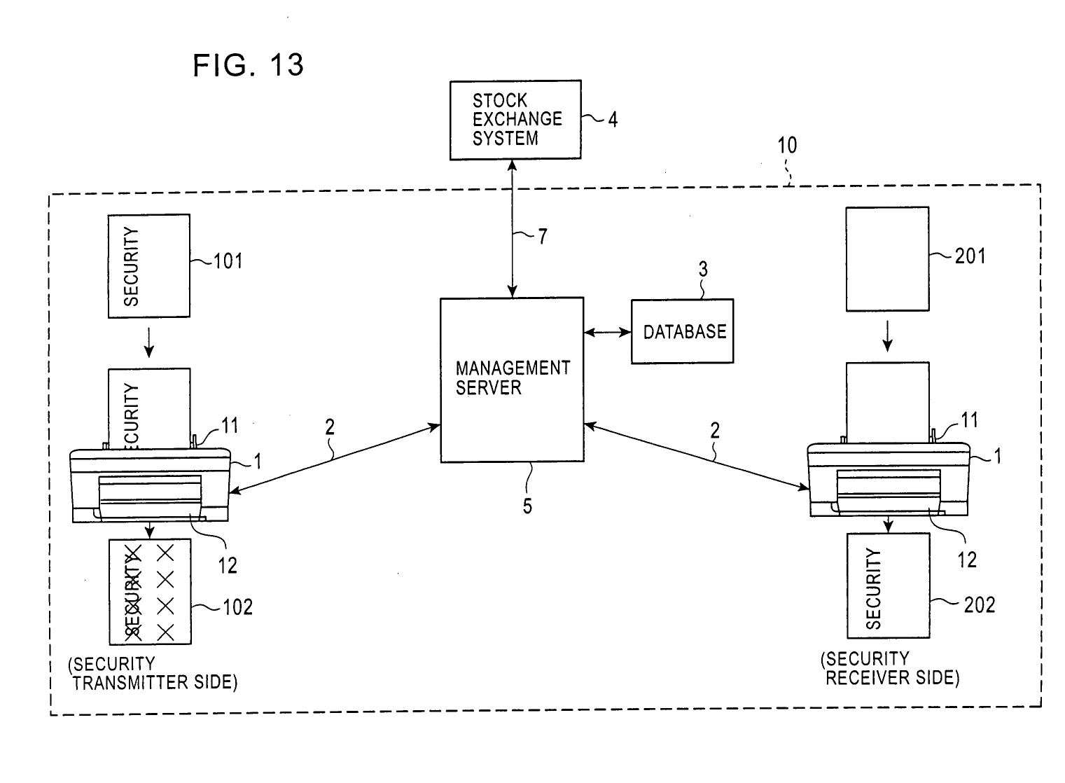

Another certificate transceiver system of the present invention is described below. FIG. 13 illustrates the structure of the certificate transceiver system. As shown in FIG. 13, elements identical to those illustrated in FIG. 1 are designated with the same reference numerals, and the discussion thereof is omitted here. A certificate transceiver system 10 of FIG. 13 includes a certificate transceiver 1 on the stock certificate transmitter side, a certificate transceiver 1 on the stock certificate transmitter side, a management server 5 for managing transmission and reception of the stock certificate, and a database 3 for storing stock certificate management data, etc.

Each certificate transceiver 1 is connected to the management server 5 via a communication line 2, such as the Internet, to exchange data with the management server 5. The management server 5 accesses the database 3, thereby performing a search operation, a write operation, a read operation, etc. The management server 5 gains access to a stock exchange system 4 via a communication line 7, thereby acquiring information relating to transfer of stocks.

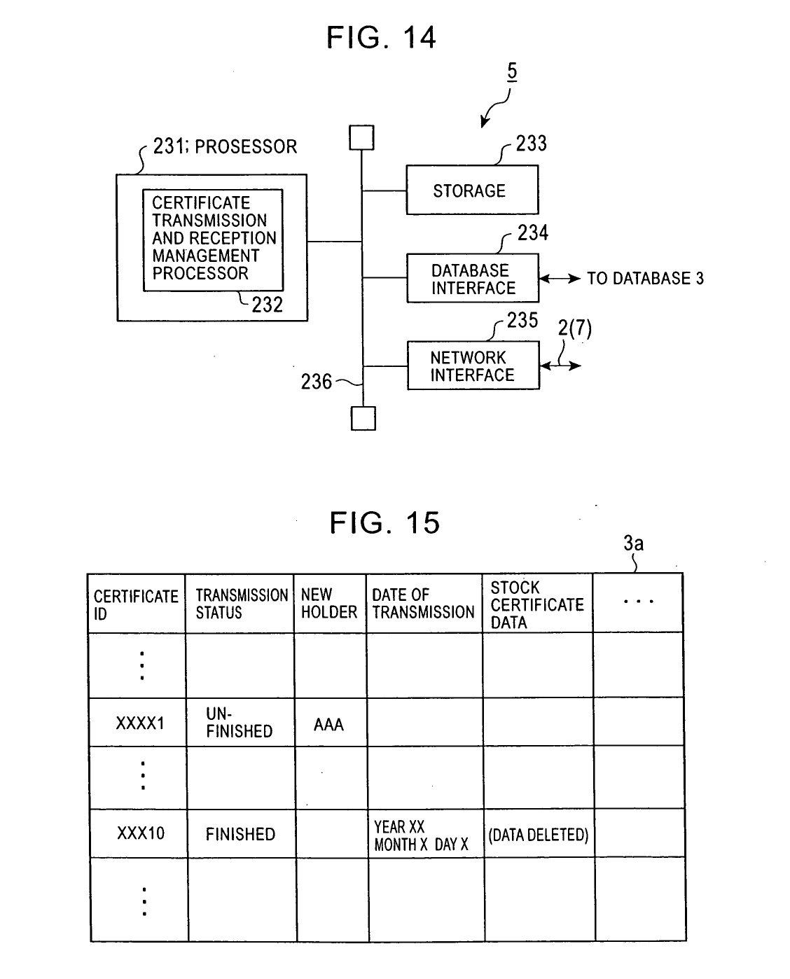

FIG. 14 illustrates the structure of the management server 5 of FIG. 13. As shown in FIG. 14, a processor 231 includes a certificate transmission and reception management processor 232. The certificate transmission and reception management processor 232 has a function for transmitting stock certificate data received from the stock certificate transmitter side to the stock certificate receiver side for printing, a function for managing a stock certificate transmission and reception process, and a function for acquiring the stock certificate information relating to the transfer of the stock from the stock exchange system 4 and recording the stock certificate information to the database 3.

The storage 233, accessed by the processor 231, stores a variety of data. A database interface 234, connected to the database 3, transmits and receives data. A network interface 235 establishes a communication line 2 (7) with each certificate transceiver 1, exchanges data with each certificate transceiver 1 via the communication line 2 (7). The network interface 235 establishes the communication line 7 with the stock exchange system 4, and exchanges data with the stock exchange system 4 via the communication line 7.

The elements designated by reference numerals 231, and 233-235 are connected to a bus 236, and data exchange is performed via the bus 236.

FIG. 15 illustrates a stock certificate management table 3a stored in the database 3 of FIG. 13. Information relating to the transfer of the stock out of the stock certificate management data is listed in FIG. 15. As shown in FIG. 15, the stock certificate management table 3a lists the transmission status of the stock certificate data (transmission finished or unfinished), the name of a new stock holder, the date of transmission of the stock certificate, and the stock certificate data with respect to the stock certificate identification information (certificate ID).

The certificate transmission and reception management processor 232 acquires the stock certificate ID of a transferred stock from the stock exchange system 4, records the stock certificate ID onto the database 3, and sets the transmission status of the stock certificate ID as being untransmitted (“unfinished” in FIG. 15). The certificate transmission and reception management processor 232 sets the transmission status of the stock certificate ID of a transmitted stock certificate as being transmitted (“finished” in FIG. 15), and records the date of the transmission. When the name of the new holder of the transferred stock certificate is acquired from the stock exchange system 4, the certificate transmission and reception management processor 232 records the name of the new holder of the stock certificate ID onto the database 3.

The certificate transmission and reception management processor 232 records the stock certificate data received from the stock certificate transmitter side onto the database 3, and deletes the stock certificate data subsequent to the end of the printing of the new stock certificate. If the name of the new holder is recorded in the database 3, the name of the new holder is included in the stock certificate data before being transmitted to the stock certificate receiver side.

The certificate transceiver system 10 uses a stock certificate 101 that has the stock certificate identification information recorded thereon as shown in FIG. 8. The stock certificate information including the pattern code 121 and the pattern 301 as characters and a pattern code is printed on the stock certificate 101. The pattern code 121 represents the stock certificate ID.

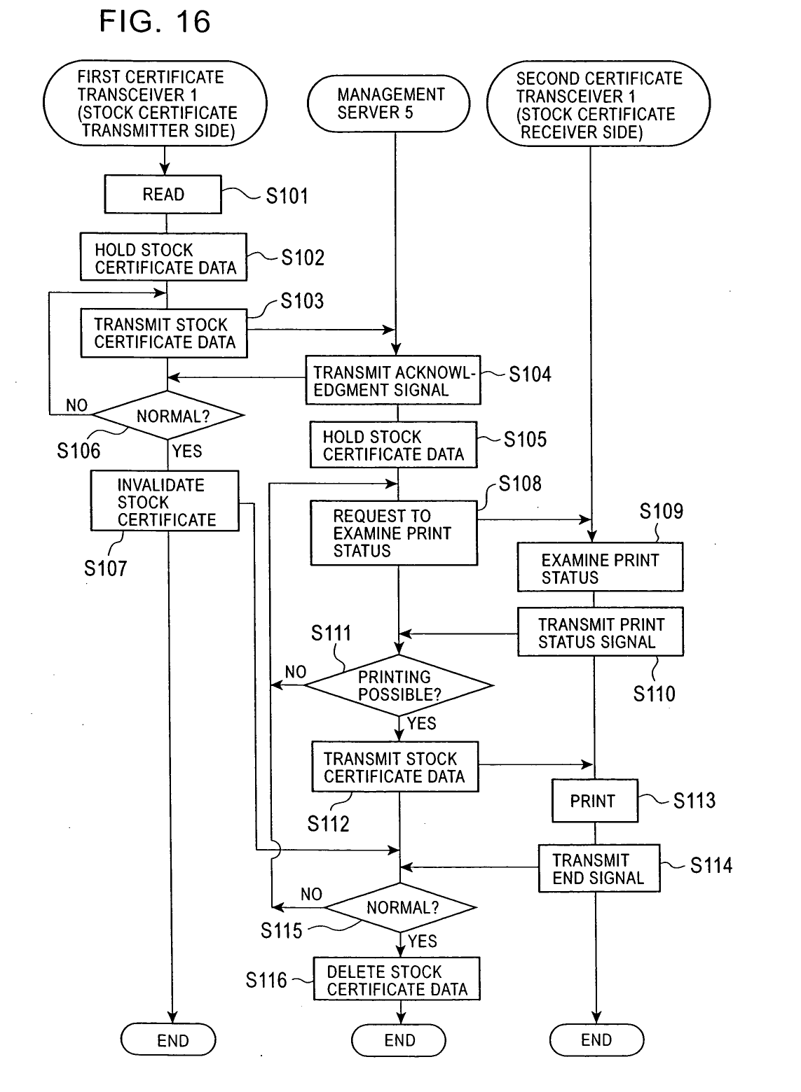

The operation of the certificate transceiver system 10 of FIG. 13 is now described with reference to a sequence chart of FIG. 16. After the conclusion of a stock certificate transfer contract, the operator instructs the certificate transceiver 1 on the stock certificate transmitter side to transmit or receive the original stock certificate 101 with the stock certificate 101 set at the certificate input port 11. In response to the instruction, the certificate transceiver 1 on the stock certificate transmitter side reads and stores the stock certificate information of the stock certificate 101, and transmits the stock certificate data to the management server 5 (steps S101, S102, and S103).

Upon receiving the stock certificate data, the management server 5 transmits an acknowledgement signal to the certificate transceiver 1 on the stock certificate transmitter side and stores the stock certificate data onto the database 3 (steps S104 and S105). The certificate transceiver 1 on the stock certificate transmitter side receives the acknowledgement signal, i.e., verifies that the management server 5 has normally received the stock certificate data. The certificate transceiver 1 on the stock certificate transmitter side writes the invalidating information over the original stock certificate 101 to invalidate the stock certificate 101. The certificate transceiver 1 on the stock certificate transmitter side notifies the management server 5 of the end of invalidation, and erases the stored stock certificate data (steps S106 and S107). On the other hand, if the certificate transceiver 1 on the stock certificate transmitter side receives no acknowledgement signal within a predetermined elapse of time subsequent to the transmission of the stock certificate data, namely, is unable to verify that the management server 5 has normally received the stock certificate data, processing returns to step S103 where the stock certificate data is transmitted again.

In step S108, the management server 5 requests the certificate transceiver 1 on the stock certificate receiver side to examine the print status. In response to the request, the certificate transceiver 1 on the stock certificate receiver side checks that own apparatus is ready to print (not in an out-of-ink state, for example), and that the stock certificate sheet 201 is set at the certificate input port 11 (step S109).

If the check results are normal, the certificate transceiver 1 on the stock certificate receiver side determines that printing is possible, sets a print status signal as being in a print possible state, and transmits the print status signal to the management server 5. If the check result is not normal, the certificate transceiver 1 on the stock certificate receiver side determines that printing is impossible, sets the print status signal as being in a print impossible state, and transmits the print status signal to the management server 5 (step S110). If printing is impossible, a print impossible message (such as the cause for the print impossible state) is displayed.

If the stock certificate receiver side is ready to print, the management server 5 transmits the stock certificate data of the database 3 to the certificate transceiver 1 on the stock certificate receiver side in response to the received print status signal. The management server 5 includes the data of the name of the new stock holder in the stock certificate data to be transmitted if the name of the new stock certificate of the stock certificate ID in the stock certificate data is recorded in the database 3 (steps S111 and S112). On the other hand, if the stock certificate receiver side cannot print, processing returns to step S108. After a predetermined time elapse, the management server 5 again requests the certificate transceiver 1 on the stock certificate receiver side to examine the print status.

In step S113, the certificate transceiver 1 on the stock certificate receiver side prints the new stock certificate 202 in accordance with the received stock certificate data, and transmits an end signal to the management server 5 at the end of the printing (steps S113 and S114). In step S115, the management server 5 verifies the end of the normal printing of the new stock certificate on the stock certificate receiver side by receiving the end signal, and verifies the end of the invalidating of the original stock certificate on the stock certificate transmitter side by receiving an invalidation end notification from the stock certificate transmitter side. The management server 5 erases the stock certificate data in the database 3 (step S116).

In the certificate transceiver system 10, the management server transmits the stock certificate information, read from the original stock certificate on the stock certificate transmitter side, to the stock certificate receiver side, and the stock certificate receiver side produces the new stock certificate based on the received stock certificate information. In this way, the new stock certificate is issued based on the original stock certificate via the communication line. Since the original stock certificate is invalidated on the stock certificate receiver side, an unauthorized use of the original stock certificate is thus prevented.

Since the management server stores the stock certificate information of the original stock certificate, the stock certificate transmitter side can invalidate the original stock certificate immediately subsequent to the verification of the transmission of the stock certificate information. The unauthorized use of the original stock certificate is more reliably controlled.

The management server records the name of the new stock holder, and includes the name of the new stock holder in the stock certificate information to be transmitted to the stock certificate receiver side. The name of the new stock holder is thus written on the new stock certificate, and time involved in the issue of the new stock certificate is reduced. The management server may record, in addition to the name of the new stock holder, information to be updated, and may include the information in the stock certificate information to be transmitted to the stock certificate receiver side. In this way, information different from that of the original stock certificate may be written on the new stock certificate.

The management server, managing the stock certificate transmission and reception, uses management information to prevent a stock certificate from being counterfeited or in the case of a forgotten transfer of the name of the stock certificate.

The certificate transceiver system may be used to transmit and receive ticket data. Audience tickets for viewing music, drama, and sports events, transportation tickets, such as airline tickets, railway tickets, etc. are exchanged among individuals (hereinafter all simply referred to as tickets.

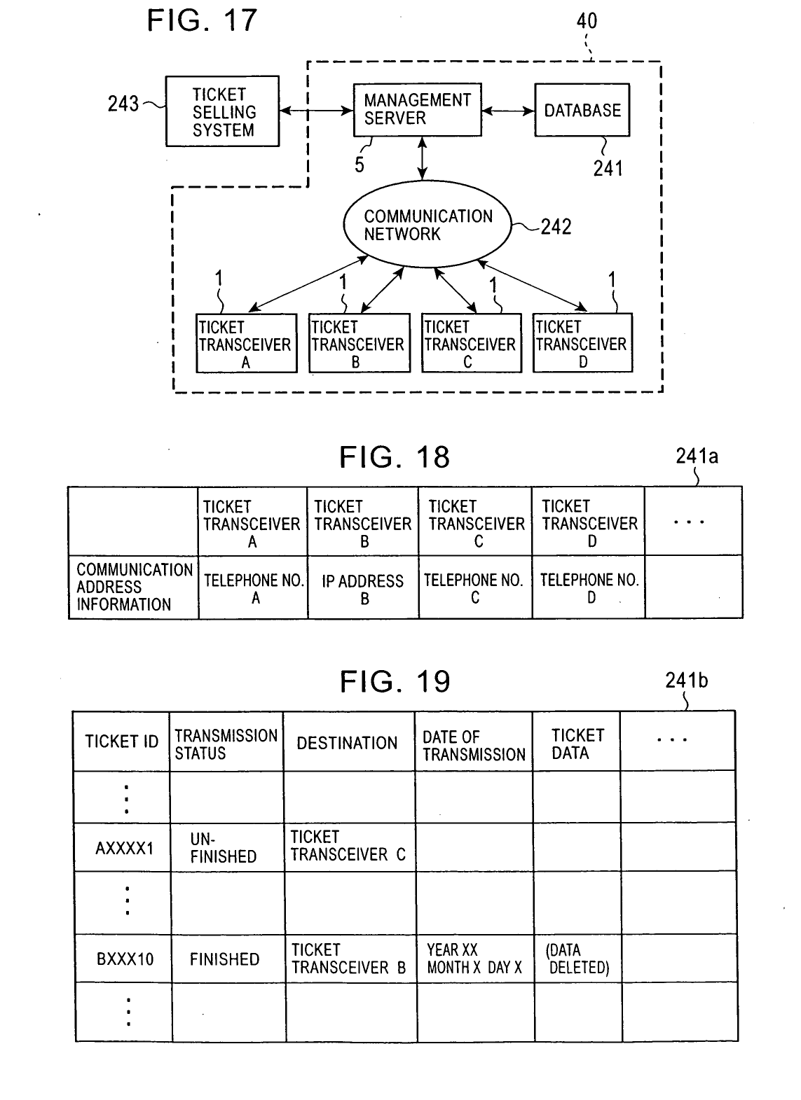

FIG. 17 illustrates such a certificate transceiver system 40. The certificate transceiver system 40 includes a plurality of certificate transceivers 1 (certificate transceivers A, B, C, D, . . . ), a management server 5 for managing transmission and reception of tickets, and a database 241 for storing ticket management data. The certificate transceiver 1 of FIG. 17 has the same structure as the certificate transceiver 1 of FIG. 2, and further includes a holder for automatically horiginaling printed tickets. The holder horiginals the printed tickets, and in response to a pickup permit, a held ticket is picked up from the outside. The structure of the management server 5 is identical to that of FIG. 14.

Each certificate transceiver 1 is connected to the management server 5 via a communication network 242 including a public telephone line and the Internet, and exchanges data with the management server 5. The management server 5 accesses the database 241, thereby searching for, writing, and reading data. The management server 5 also accesses a ticket selling system 243 via a communication line, thereby acquiring information relating to ticket selling. The certificate transceivers 1 (certificate transceivers A, B, C, D, . . . ) are installed in stores to which customers have an easy access. For example, the certificate transceivers 1 may be installed in convenience stores that could be located on a nation-wide scale. For convenience of customers, stores that open 24 hours a day, and 7 days a week are preferable.

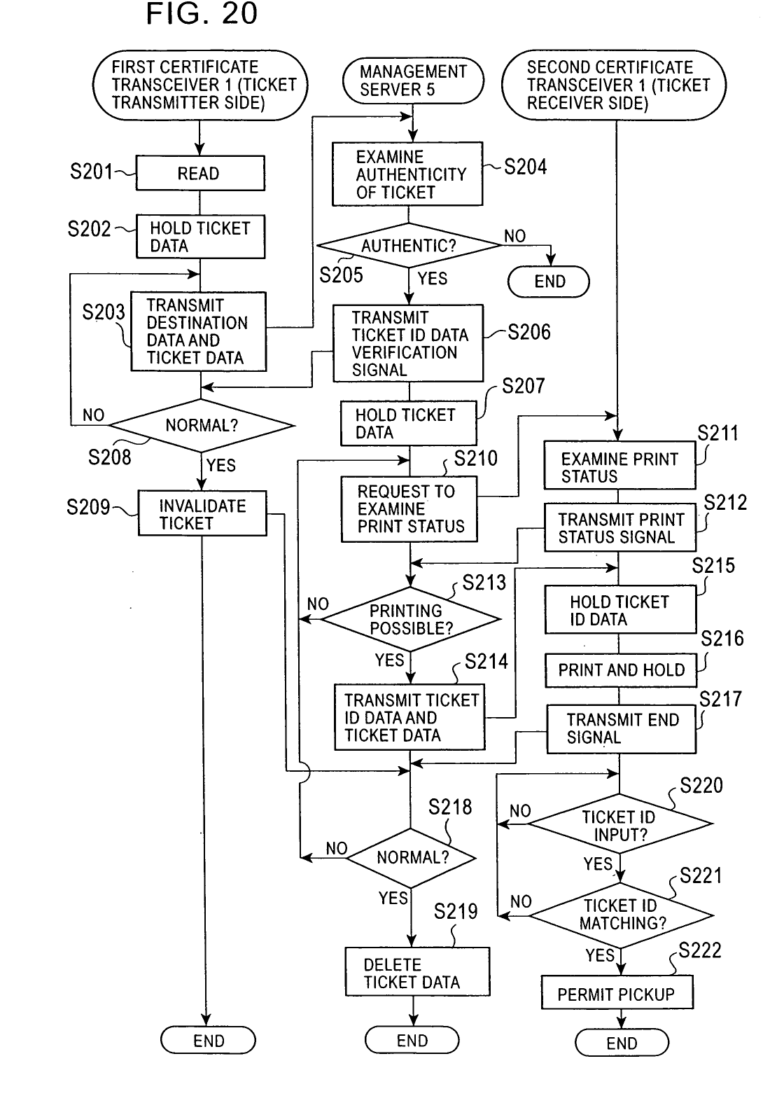

FIG. 18 illustrates a communication address management table 241a stored in the database 241 of FIG. 17. FIG. 19 illustrates the structure of a ticket management table 241b stored in the database 241 of FIG. 17. As shown in FIG. 18, the communication address management table 241a stores beforehand communication address information (telephone numbers and IP addresses) of the certificate transceivers A, B, C, D, . . . The management server 5 performs data communications with the certificate transceiver 1 on the ticket receiver side using the communication address information. As shown in FIG. 19, the management server 5 stores, in the ticket management table 241b, the transmission status of ticket data (transmission finished or unfinished), the destination of the ticket data, the date of transmission of the ticket data, the ticket data, etc. with respect to ticket identification information (ticket ID).

The operation of the certificate transceiver system 40 of FIG. 7 is described below with reference to a sequence chart of FIG. 20. As shown in FIG. 20, a ticket provider sets a ticket in the certificate transceiver 1 to transmit ticket data to the certificate transceiver 1 at a desired location, specifies the certificate transceiver 1 at the destination (namely the certificate transceiver 1 on the ticket receive side), and issues an instruction to transmit the ticket data. In response to the instruction, the certificate transceiver 1 on the ticket transmitter side reads ticket information from the set ticket and transmits ticket data to the management server 5 in the same manner as in steps S101-S103 of FIG. 16. The certificate transceiver 1 on the ticket transmitter side also transmits destination data to the management server 5 (steps S201-S203).

Upon receiving the ticket data and the destination data, the management server 5 transmits the ticket data to the ticket selling system to request the ticket selling system to examine authenticity of the ticket. If the examination result shows that the ticket is unauthentic, the management server 5 ends processing. If the examination result shows that the ticket is authentic, the management server 5 issues a ticket ID, and transmits the data of the ticket ID and an acknowledgement signal to the certificate transceiver 1 on the ticket transmitter side. The ticket data associated with the ticket ID and the destination data are stored in the database 41. The management server 5 sets the transmission status in transmission unfinished (steps S204-S207).

As in steps S106 and S107 of FIG. 16, the certificate transceiver 1 on the ticket transmitter side invalidates the ticket in response to the received acknowledgement signal, notifies the management server 5 of the end of the invalidation process, and deletes the stored ticket data in steps S208 and S209. The certificate transceiver 1 on the ticket transmitter side displays the received ticket ID data. The ticket provider notifies a ticket receiving customer of the displayed ticket ID and the location of the certificate transceiver 1 as the destination.

As in steps S108-S111 of FIG. 16, the print status of the certificate transceiver 1 on the ticket destination (ticket receiver side) is examined in step S210-S213. If the examination result shows that printing is possible, the management server 5 transmits the ticket ID data and the ticket data to the certificate transceiver 1 on the ticket receiver side (step S214).

The certificate transceiver 1 on the ticket receiver side stores the received ticket ID data. The certificate transceiver 1 on the ticket receiver side prints ticket information on a ticket sheet based on the received ticket data, and horiginals the printed ticket (steps S215 and S216). The certificate transceiver 1 on the ticket receiver side transmits an end signal to the management server 5 (step S217).

As in steps S115 and S116 of FIG. 16, the management server 5 deletes the ticket data in the database 241 in response to the received end signal in steps S218 and S219.

The ticket receiving customer operates the certificate transceiver 1 (on the ticket receiver side) at the location received from the ticket provider to input the received ticket ID. If the input ticket ID matches a stored ticket ID, the certificate transceiver 1 on the ticket receiver side issues a pickup permit to the holder (steps S220-S222). Since the ticket has already been printed, the ticket receiving customer picks up and gets the ticket from the certificate transceiver 1 without no waiting time for printing.

If the ticket IDs fail to match each other in step S221, the certificate transceiver 1 on the ticket receiver side displays a message prompting the customer to enter the ticket ID again, and returns to step S220 to wait form the input of the ticket ID. If the ticket ID input in step S221 matches the stored ticket ID, processing proceeds to step S222 to permit the holder to be ready for pickup. If the number of unmatched results between the input ticket ID and the stored ticket ID reaches a predetermined count (for example, 2), the ticket receiving customer can be an unauthentic customer, and an alarm sound may be triggered.

As the certificate transceiver system 10 of FIG. 13, the certificate transceiver system 40 issues the new ticket based on the original ticket via the communication line, and an unauthorized use of the original ticket is prevented.

The management server transmits the ticket data to the certificate transceiver 1 at the designated destination, and the certificate transceiver 1 produces the new ticket. The user receives the new ticket at a desired location (such as the destination of a business trip).

The certificate transceiver 1 on the ticket receiver side horiginals beforehand the ticket that is produced based on the received ticket data. The ticket receiving customer gets the ticket without waiting time for printing.

The management server transmits the ticket ID together with the ticket data to the ticket receiver side, and the certificate transceiver 1 permits the customer to pick up the ticket on condition that the received ticket ID and the ticket ID as an operational input. The ticket receiving customer is authenticated based on the ticket ID, and the reliability of the ticket delivery is heightened.

Since the management server 5 authenticates the original tickets, the illegal issue of a new ticket is controlled.

The certificate transceiver system 40 may be applied for person to person selling and buying. One example of the person to person ticket selling and buying is described below. A contract for sale of ticket is concluded between individuals (a seller and a buyer) via the Internet or telephone. The seller conveys an ID number to the buyer. The buyer conveys the location of the certificate transceiver 1 for receiving the ticket (such as a nearby convenience store).

The seller sets the seller's ticket in the certificate transceiver 1 installed in a convenience store located nearby to read the information of the ticket, and sets the certificate transceiver 1 installed at a location designated by the buyer as a destination. Subsequent to the conclusion of the contract, the buyer goes to the location of ticket reception. In the meantime, the ticket data is transmitted from the certificate transceiver 1 that has read the ticket to the certificate transceiver 1 at the location of ticket reception, and the ticket is printed. Upon arriving at the location of ticket reception, the buyer enters the ID number into the certificate transceiver 1 and gets the ticket. The certificate transceiver 1 on the seller side invalidates the read ticket data.

Subsequent to the conclusion of the contract of sale, the seller quickly causes the certificate transceiver 1 in a nearby convenience store to read the information of the ticket for ticket transmission. Subsequent to the conclusion of sale, the buyer immediately receives the ticket in a nearby convenience store. The transfer of valuable papers (such as tickets) is thus quickly performed.

In the certificate transceiver system 40 of FIG. 17, the certificate transceiver 1 on the ticket receiver side prints the ticket beforehand. Alternatively, the ticket data is stored in association with the ticket ID. The ticket is printed and handed over to the customer on condition that the ticket IDs match each other at the ticket delivery. In this way, there is no need for preparing a holding space for the issued tickets. Since the ticket is stored in the form of ticket data before delivery, the certificate transceiver 1 can receive, from the 5, a large number of tickets to be delivered.

The ticket ID in the form of a bar code may be recorded onto the ticket at the sale, and the certificate transceiver 1 on the ticket transmitter side may read the ticket ID from the ticket, and notify the management server 5 of the ticket ID. In this arrangement, management of the ticket ID is facilitated. The management server 5 then transmits the ticket ID to the ticket selling system to request the ticket selling system to examine the authenticity of the ticket. The examination of the authenticity of the ticket is thus easily performed.

The embodiments of the present invention have been discussed with reference to the drawings. The present invention is not limited to these embodiments, and a modification of the present invention is possible without departing from the present invention.

1. A certificate transceiver comprising:
data reading means,
data writing means,
storage means for temporarily storing data read by the data reading means, and
communication means for transmitting and receiving data via a communication line,
wherein when the data of a certificate of value is transmitted, the data reading means reads data from the certificate, the storage means stores the certificate data, the communication means transmits the certificate data, and the data writing means writes invalidating data on the certificate to invalidate the certificate data, and deletes the certificate data from the storage means, and
wherein when the certificate data is received, the data writing means writes certificate data received, by the communication means, onto a recording medium of a certificate.

2. The certificate transceiver according to claim 1, wherein the recording medium comprises a contactless rewritable non-volatile memory,
wherein the data reading means reads data from the non-volatile memory, embedded in the certificate, in a contactless manner, and
wherein the data writing means writes data onto the non-volatile memory, embedded in the certificate, in a contactless manner.

3. The certificate transceiver according to claim 1, comprising data printing means,
wherein the data printing means prints the invalidating data on the certificate to invalidate the data of the certificate.

4. The certificate transceiver according to claim 1, comprising certificate information storage means for storing the certificate data with certificate identification information associated therewith for identifying the certificate,
wherein during the transmission, the data reading means reads the certificate identification information recorded on the certificate, and the communication means transmits the read data of the certificate identification information, and
wherein during the reception, the certificate data is read from the certificate information storage means in accordance with the data of the certificate identification information received by the communication means, and the data writing means writes the certificate data onto the recording medium.

5. The certificate transceiver according to claim 1, wherein at least variable data of the certificate data is modifiable.

6. The certificate transceiver according to claim 5, comprising data input means,
wherein the variable data is modified by entering data via the data input means.

7. The certificate transceiver according to claim 5, wherein the communication means establishes a connection with a database that is accessible via a communication line and has recorded the latest variable data and the variable data is modified in accordance with the content of the database.

8. A certificate transceiver system comprising a certificate transmitter including reading means for reading certificate information recorded on a certificate of value, invalidating means for invalidating the certificate, and first communication means for transmitting the certificate information via a communication line, and
a certificate receiver including second communication means for receiving the certificate information via the communication line, and writing means for writing the received certificate information onto a recording medium of the certificate.

9. The certificate transceiver system according to claim 8, comprising certificate information storage means for storing image data as one piece of the certificate information with certificate identification information associated therewith for identifying the certificate,
wherein the reading means reads the certificate identification information as one piece of the certificate information,
wherein the first communication means transmits the read certificate identification information via the communication line, and
wherein the writing means acquires the image data, from the certificate information storage means, corresponding to the certificate identification information received by the second communication means, writes the image data onto an image recording medium, and writes the certificate identification information onto a digital recording medium.

10. The certificate transceiver system according to claim 9, wherein the certificate receiver comprises calculating means for generating a pattern of the certificate based on the received certificate identification information.

11. The certificate transceiver system according to claim 9, wherein the writing means writes substantially circular patterns, each pattern having a diameter as a reading area limit of the reading means, and the patterns spaced from each other by a distance of integer multiple of the diameters, and forms a pattern code representing a particular certificate identification information using the patterns, and
wherein the reading means reads the patterns within a range extending by a distance of an integer multiple of the diameters and reads the pattern code recorded on the certificate.

12. The certificate transceiver system according to claim 8, wherein the recording medium comprises a non-volatile memory.

13. The certificate transceiver system according to claim 12, wherein the non-volatile memory comprises a one-time PROM, and
wherein the invalidating means performs an overwrite process on the one-time PROM.

14. The certificate transceiver system according to claim 12, wherein the non-volatile memory is arranged in an IC chip,
wherein the IC chip, connected to an antenna, is embedded together with the antenna within the sheet of the certificate, and
wherein each of the invalidating means and the writing means gains access to the IC chip after each of the invalidating means and the writing means successfully completes an authentication process with the IC chip.

15. The certificate transceiver system according to claim 8, wherein the invalidating means comprises printing means for printing invalidating information on the certificate.

16. The certificate transceiver system according to claim 8, wherein the invalidating means comprises shredding means for shredding the certificate.

17. The certificate transceiver system according to claim 8, wherein one of the certificate transmitter and the certificate receiver comprises input means for inputting data to partially modify the certificate information to be written onto the recording medium, and
wherein the certificate transmitter transmits the input data to the certificate receiver via the communication line.

18. The certificate transceiver system according to claim 8, comprising third communication means for communicating with one of the certificate transmitter and the certificate receiver, and
a certificate transmission and reception management device including storage means for storing the certificate information, and certificate transmission and reception management processing means for receiving the certificate information from the certificate transmitter, storing the certificate information in the storage means, and transmitting the certificate information to the certificate receiver.

19. The certificate transceiver system according to claim 18, wherein the invalidating means starts invalidating the certificate when the certificate transmitter determines that the transmission of the certificate information to the certificate transmission and reception management device has been normally completed.

20. The certificate transceiver system according to claim 18, wherein the stored certificate information is deleted when the certificate transmission and reception management device determines that the writing of the certificate receiver has been normally completed.

21. The certificate transceiver system according to claim 18, wherein the certificate transmission and reception management device sets, in the certificate information to be transmitted, replacement information stored beforehand in the storage means.

22. The certificate transceiver system according to claim 18, wherein the certificate transmitter comprises input means for inputting transmission destination information for identifying the certificate receiver, and transmits the input transmission destination information to the certificate transmission and reception management device, and
wherein the certificate transmission and reception management device transmits the certificate information to the certificate receiver corresponding to the received transmission destination information.

23. A certificate transmission and reception method comprising:
a step for examining whether or not a certificate of value can be printed on a certificate receiver side,
a step for reading certificate information recorded on an original certificate on a certificate transmitter side and transmitting the certificate information via a communication line if the certificate can be printed on the certificate receiver side,
a step for writing the received certificate information on a recording medium for the certificate on the certificate receiver side, and
a step for invalidating the original certificate on the certificate transmitter side.

24. The certificate transmission and reception method according to claim 23, further comprising a step of the certificate receiver side for notifying the certificate transmitter side of the cause for a print impossible state based on the examination result if the examination result shows that the certificate cannot be printed.

25. The certificate transmission and reception method according to claim 23, further comprising a step of the certificate receiver side for notifying, via a communication line, the certificate transmitter side of the end of the writing to the recording medium, and
wherein the certificate transmitter side starts an invalidating process at the moment the certificate transmitter side receives the notification of the end of the writing.

26. The certificate transmission and reception method according to claim 23, further comprising a step of checking whether or not the telephone number of a connection partner of the communication line is a registered telephone number, the communication line being a public telephone line from which the telephone number of the connection partner is available, and
wherein one of the transmission and the reception of the certificate information is performed if the check result shows that the telephone number is registered, and one of the transmission and the reception of the certificate information is not performed if the check result shows that the telephone number is not registered.

27. A certificate transmission and reception method comprising:
a step of a certificate transmitter side for reading certificate information recorded on a certificate of value and invalidating the certificate,
a relay step for receiving the certificate information from the certificate transmitter side, storing the certificate information, and transmitting the certificate information to a certificate receiver side, and
a step of the certificate receiver side for writing the received certificate information onto a recording medium for the certificate, and then holding the recording medium.

28. The certificate transmission and reception method according to claim 27, comprising a step for notifying the certificate receiver side of certificate identification information of the certificate, and
a step of the certificate receiver side for delivering the held recording medium to a user if certificate identification information input by the user matches the notified certificate information.

29. The certificate transmission and reception method according to claim 27, wherein the relay step comprises authenticating the certificate.

30. The certificate transmission and reception method according to claim 28, wherein the certificate identification information is recorded onto the certificate.

31. A certificate transmission and reception method comprising:
a step of a certificate transmitter side for reading certificate information recorded onto a certificate of value and invalidating the certificate,
a relay step for receiving and then storing the certificate information from the certificate transmitter side, and transmitting the certificate information to a certificate receiver side,
a step of the certificate receiver side for storing the received certificate information,
a step for notifying the certificate receiver side of certificate identification information of the certificate, and
a step of the certificate receiver side for writing the stored certificate information onto a recording medium and delivering the recording medium to a user if certificate identification information input by the user matches the notified certificate identification information.

32. The certificate transmission and reception method according to claim 31, wherein the relay step comprises authenticating the certificate.

33. The certificate transmission and reception method according to claim 32, wherein the certificate identification information is recorded onto the certificate.
